(19) United States
(12) Patent Application Publication
(10) Pub. No.: US 2010/0061214 A1
(43) Pub. Date: Mar. 11, 2010

(54) APPARATUS AND METHOD FOR THE PRODUCTION OF A HOLOGRAM IN AN OPTICAL MEDIUM

(75) Inventors: Susanna Orlic, Berlin (DE); Enrico Dietz, Bernau (DE); Christian Mueller, Berlin (DE)

Correspondence Address: HARNESS, DICKEY & PIERCE, P.L.C., P.O. BOX 828, BLOOMFIELD HILLS, MI, 48303, US

(73) Assignee: TECHNISCHE UNIVERSITAET BERLIN, Berlin (DE)

(21) Appl. No.: 12/523,891

(22) PCT Filed: Jan. 20, 2008
(86) PCT No.: PCT/EP08/50601

§ 371 Date: Jul. 21, 2009

(30) Foreign Application Priority Data
Jan. 22, 2007 (DE) 10 2007 004 025.5

(51) Int. Cl. G11B 7/00

(52) U.S. Cl. 369/103; 369/112.23; G9B/7

(57) ABSTRACT

The invention relates to a method and a device for producing a hologram in an optical medium, particularly for storing data in the optical medium. In the method, the hologram is produced in the optical medium using laser beams, wherein the laser beams are formed from a laser beam emitted by a free-running semiconductor laser, are directed onto the optical medium, optionally contradirectionally, and at least partially spatially overlap in the optical medium. For producing holograms using inexpensive components with a high contrast, the invention provides for arranging the reflection unit (15) such that the optical path length (Δx) between the focus of the laser beam in the storage medium (10) and the reflecting surface of the reflection unit (15) satisfies the condition Δx=0.5*Δs*a in the region of the optical axis, wherein a is a natural number greater than or equal to 1 and Δs is a distance between neighboring coherence centers of the laser beam produced by the semiconductor laser (16).

### FIELD

The invention relates to a device and a method for producing a hologram in an optical medium, particularly for storing data in the optical medium.

### BACKGROUND

Optical storage systems in the form of CD and DVD drives have been the worldwide standard for data storage, exchange and archiving as well as for diverse multimedia applications in the field of consumer electronics for several tens of years. In all fields there is a constantly growing need for storage capacity with simultaneous very high requirements for the security of stored data.

The success of the optical disc as a mass data storage unit is based primarily on compactness as well as on the low final price of drives and data carriers. A DVD drive represents a very efficient optical system which is composed exclusively of components which can be advantageously fabricated in mass production. Reading and writing of digital data in the storage medium takes place with a focused laser beam without contact.

Currently, two different optical area storage systems have the potential of establishing themselves as a new standard for removable optical storage units. HD-DVD and BluRay both profit from the change to a blue laser diode at 405 nm as a modulatable light source for writing and reading. The reduction of the wavelength causes an increase in the optical resolution, so that area storage densities of 15 GByte (HD-DVD) or as much as 25 GByte are reached in the new systems by using a more refractive objective for focusing into the disc (BluRay). Further, to increase the data capacity, several independent storage layers are arranged on top of each other, which is already being applied in the current “red” DVD generation and in that case leads to a total capacity of 9 GB. This technique is limited in that every layer has to reflect as much light as possible, in order to enable a good read-out signal, but simultaneously requires a high transmission, so that large enough parts of the writing/reading beam can still penetrate into deeper layers. Further, every storage layer must exhibit a minimum of absorption so that it can be modified thermally by absorbed laser light during the writing process. In practice, these conflicting requirements result in the use of three storage layers arranged on top of each other with a total capacity of 45 GByte in the HD-DVD system and two layers with a total of 50 GByte in the BluRay disc.

The fourth generation of optical data storage units will be determined by holographic volume storage systems. The significant improvement of photopolymers as storage materials during the last years has enabled a leap in innovation in the holographic storage of data, so that by now several competing systems have entered the phase of successful technical implementation. In general, the development of optical storage in the last 15 years has shown that an elementary factor for the success of a new standard is its downward compatibility to the preceding systems. For this reason, every DVD player today is able to handle CDs, and DVDs and CDs can also still be used in HD-DVD and BluRay devices.

For the fourth generation of optical storage units, this means that a bit-oriented concept like that of the micro-holographic storage system, which is technologically very similar to the existing systems, offers a clear advantage over systems like page-oriented holographic storage, whose technology hardly allows for the preceding formats to be used in a preferably simply structured device.

Holographic storage is generally based on the superposition of two laser beams coherent with each other, often called signal and reference beam. The three-dimensional modulated intensity distribution resulting from interference of the two beams is written into a transparent storage medium, often a photosensitive polymer, through local modification of its optical characteristics. If the volume lattice produced in this way is illuminated with only one of the two original writing beams (reference beam), a reconstruction of the respective other beam (signal beam) occurs through optical diffraction of this beam by the lattice. The stored information is located either in the modulation of the intensity profile of the signal beam, which is evaluated with a CCD detector (page-oriented storage), or simply based on whether or not a lattice exists at the addressed position (bitwise storage).

The reconstruction of the signal beam is described physically by Bragg diffraction of the reference beam by the volume lattice. Here, satisfying the Bragg condition implies that the reading beam has the same wavelength, direction and focusing as the reference beam originally used for writing. Otherwise the diffraction efficiency as a measure of the ratio of read-out light power to incident light power quickly tends to zero, and the storage medium becomes transparent again.

This principle offers the possibility of increasing the storage density of such a volume storage unit by applying holographic multiplexing. Herein, several volume lattices are inscribed into the same spatial position with different signal and reference beams without interaction. Addressing of a single lattice is then performed using the respective reference beam used for writing, so that only the corresponding signal beam is reconstructed. Different multiplexing methods result for example from changing the wavelength of both writing beams, the angle or the phase of the reference beam or, in the case of focused writing beams, the position of both writing focuses in the depth of the storage material.

Micro-holographic storage takes place in a manner very analogous to the area storage systems described above. The data is written bitwise into concentric tracks of a rotating disc with a laser beam focused on the optical boundary, for example with a wavelength of 405 nm. Addressing of particular positions on the disc is performed utilizing servo tracking mechanisms very similar to the ones used in DVD systems. During writing, the data stream is converted into a high-frequency modulation of the employed laser according to an encoding method compatible with the DVD encoding EFM/EFM+. This is designed such that the laser power assumes a constant value on average, which means that the laser is turned off and on for approximately the same amount of time. Binary ones are represented as a transition between regions of high and low reflectivity. The number of switching actions of the laser is minimized by the encoding method in that the minimum length between two transitions is for example always three zero bits. The length of a single bit results from the rotational speed of the disc and the clock pulse as the smallest time unit in which the laser can be switched, analogous to a red DVD at 133 nm.

The great difference with respect to the classical systems lies in the representation of the digital data in the storage medium by microscopic reflection lattices instead of the pit-land structure of a DVD. These so-called micro-holograms result from the coherent superposition of two focused contradirectional laser beams in a photosensitive polymer. FIG. 1 illustrates a conventional beam geometry at the writing location: A focused laser beam 2 which is directed by a laser diode 5 into a storage medium 1 passes through the storage medium 1, which is a photopolymer, up to a reflection unit 3, where it is reflected in such a way that the focus of a reversed laser beam 4 is superimposed exactly with the focus of the incident laser beam 2. In order for a micro-hologram to be able to form in the photopolymer by interference of the two laser beams 2, 4, the temporal coherence of the incident focused laser beam 2 must lead to a coherence length of more than the doubled distance 2·Δx between storage location and reflection unit 3. In conventional devices, distances of Δx≧10 mm are used. Correspondingly high requirements are to be placed on the coherence length of the laser being used.

Holographic storage makes especially high demands on stability and beam quality of the employed laser system. In particular, mode jumps must be prevented for the duration of a writing cycle, and the coherence length of the laser beam must be larger than the path length difference between signal and reference beam starting from the position of the division into two beams. Therefore, complex and expensive laser systems like external cavity diode lasers, which allow for single-mode operation with coherence lengths of several hundred meters due to external mode selection, or stabilized gas lasers are typically used for holography. Due to their size and complexity, such lasers are not suitable for use in a compact storage system.

A micro-holographic data storage unit with three-dimensional striped lattices is known from DE 101 34 769 A1. The known optical storage system allows bit-oriented dynamic writing of data as three-dimensional stripe-shaped reflection lattices into a photosensitive layer and to read it out therefrom. The lattice is formed holographically using strongly focused laser beams and is spatially limited to a submicrometer range in all directions. For writing, a laser beam is focused into a storage layer and imaged with a reflecting unit such that the incident and the reflecting beam with opposite propagation directions are superimposed exactly and the common beam waist is located at a specific depth of the storage layer. During recording, the storage layer is moved perpendicular to the beam axis. This produces stripe-shaped micro-lattices of different length corresponding to the writing times. The read-out signal is produced by diffraction under Bragg conditions.

### SUMMARY

The object of the invention is to provide a device and a method for producing a hologram in an optical medium that allows the production of a hologram using inexpensive components with a high contrast.

According to the invention, this object is achieved by a device according to the independent claims 1 and 17 and a method according to the independent claims 34 and 35. Preferred embodiments of the invention are contained in the dependent claims.

The invention comprises the thought of using the laser beam generated by a free-running semiconductor laser, which is for example a free-running laser diode, for writing a hologram. Free-running means that the laser beam generated by the semiconductor laser is not passed through an external resonator and is thus used for hologram writing without a resonator. The proposed method and the device provide for employing a free-running semiconductor laser without external stabilization or mode selection for writing holograms. The use of complex laser systems which is common in the state of the art can be dispensed with, thereby saving effort and cost. Herein the coherence length of the laser beam emitted by the free-running semiconductor laser is usually only several 100 μm.

The device according to the invention comprises a semiconductor laser, a reception means for a storage medium; a means for focusing the laser beam produced by the semiconductor laser into the storage medium, and a reflection unit with a reflecting surface, which is adapted to focus at least a part of the laser beam of the semiconductor laser passing through the storage medium back into the storage medium, the reflection unit being arranged such that the following condition is satisfied:

$$2 {\int }_{P 1}^{P 2} n ( z ) d z = a * Δ s \pm 150 µm ,$$

wherein P1 is the location of the focus of the laser beam of the semiconductor laser in the storage medium, P2 is the intersection of the reflecting surface of the reflection unit with the optical axis defined by the laser beam of the semiconductor laser, n(z) is the refractive index of the medium between the points P1 and P2 along the optical axis, a is a natural number greater than or equal to 1, and Δs is a distance between neighboring coherence centers of the laser beam produced by the semiconductor laser. Preferably, the semiconductor laser is a laser diode with a Fabry-Perot resonator.

The value ±150 μm indicates that the distance between the focus and the reflecting surface of the reflection unit does not have to be set exactly to the maximal contrast of the coherence but that this dependence is required in the range of certain tolerances. Preferably, this tolerance is equal to zero, but for the implementation of the invention it is sufficient to adjust the distance between the focus and the reflecting surface of the reflection unit according to the condition

$$2 {\int }_{P 1}^{P 2} n ( z ) d z = a * Δ s$$

with tolerances within the range of the local region of high coherence. Thus, the optical path length between the location of the focus of the laser beam of the semiconductor laser in the storage medium and the intersection of the reflecting surface of the reflection unit may preferably have a tolerance of ±500 μm, more preferably ±150 μm, still more preferably ±50 μm and still more preferably ±10 μm and still more preferably ±0 μm. Accordingly, the tolerances in the formulas containing Δs are preferably to be replaced by ±500 μm (instead of ±150 μm), more preferably by ±50 μm, still more preferably by ±10 μm and still more preferably by ±0 μm.

The idea of the invention lies in matching the coherence characteristics of inexpensive semiconductor lasers to the path difference between focused radiation and contradirectionally superimposed radiation such that the interference pattern produced and hence also the holograms to be produced have as much contrast as possible. In other words, the path difference between focused radiation and contradirectionally superimposed radiation (that is the distance between the reflecting surface of the reflection unit and the focus in the storage medium) is selected in consideration of a distance Δs between coherence centers of the laser beam emitted by the free-running semiconductor laser.

Coherence length refers to the shortest distance along the propagation direction of the laser beam within which coherence is first lost. The associated coherence time roughly corresponds to the reciprocal of the spectral bandwidth of the radiation emitted by the laser. Since a laser diode does not emit a continuous spectrum, but discrete modes with constant mode distance, coherence regions (coherence centers) which all have substantially the same width exist at intervals of integer multiples of the resonator length. For larger distances their contrast declines since the single modes also have a finite bandwidth. The radiation emitted by a laser diode (with a Fabry-Perot resonator) has a periodic coherence function (also referred to as base coherence) resulting in periodically occurring and spatially limited regions of high coherence. The invention relates to radiation sources that have periodically occurring regions of high coherence with a comparatively low coherence length. Preferably, the contrast of the periodically occurring regions of high coherence is at least twice (more preferably at least five times) as high as the regions of low (or no) coherence therebetween.

The storage medium is preferably formed by a disc or a plate which has a photosensitive layer (preferably a photopolymer) arranged between two substrates (with a thickness preferably between 0.1 mm and 2 mm), wherein the refractive index of the photosensitive layer undergoes a change upon incidence of electromagnetic radiation. The means for focusing is preferably formed by one or more lenses. The reflection unit is preferably formed by one or more lenses in combination with a plane mirror. Alternatively, the reflection unit can be formed by a curved mirror. The function of the reflection unit is to reflect the diverging radiation of the semiconductor laser (after it has been directed through the focus) back into itself, so that the radiation is focused into the storage medium again and is contradirectionally superimposed with itself. If the reflection unit comprises several reflecting surfaces (for example in the case of a retroreflector), the point P2 is understood to be the intersection of the optical axis defined by the laser beam of the semiconductor laser with the reflecting surface of the reflection unit causing a beam reversal. As a rule, the intersection of all surfaces of a retroreflector with the optical axis (=laser beam) will be the same. Should a reflection unit be formed such that several reflecting surfaces cause the beam reversal, the point P2 is understood to be the intersection of the optical axis defined by the laser beam of the semiconductor laser with the reflecting surface of the reflection unit that is arranged as the last face in the beam path. Then n(z) is the refractive index of the medium between the points P1 and P2 along the beam course up to the last surface causing the beam reversal.

Preferably, the semiconductor laser is a laser diode with a central wavelength between 300 nm and 430 nm (more preferably between 380 nm and 430 nm). The free-running semiconductor laser being used, which is preferably a free-running laser diode, preferably has an emission wavelength in the blue-violet spectral range. This allows the use of the same compact diode lasers for writing the hologram that are manufactured for DVD drives in large quantities at a low price with high quality. A further advantage of this design is that the free-running semiconductor laser can be modulated directly since thereby the powerful and perfected encoding algorithms and signal processing techniques of the DVD technology can be implemented directly into the holograms. Both the data encoding and the signal processing are carried out in DVD drives by highly integrated and miniaturized semiconductor components. The direct application in a data storage system which is possible without adjustment presents a substantial decrease of the technological and financial effort in development.

Preferably, the reflection unit is arranged such that the optical path length between the focus of the laser beam in the storage medium and the reflecting surface of the reflection unit satisfies the condition Δx=0.5*Δs*a in the region of the optical axis, wherein a is a natural number greater than or equal to 1 and Δs is a distance between neighboring coherence centers of the laser beam produced by the semiconductor laser. Preferably, the laser diode has a front facet and a rear facet as an internal resonator (Fabry-Perot resonator), wherein the distance between neighboring coherence centers satisfies the condition Δs=r, and r is the distance between the front facet and the rear facet of the internal resonator of the laser diode.

Preferably, the device does not comprise an external resonator for the semiconductor laser. Preferably, the radiation of the semiconductor laser has a coherence length less than 500 μm, more preferably between 500 μm and 5 μm (still more preferably between 500 μm and 50 μm). This does not rule out, however, that periodically occurring regions of high coherence are present at intervals greater than the coherence length, which according to the invention are used for adjusting the optical path length between the location of the focus of the laser beam of the semiconductor laser in the storage medium and the intersection of the reflecting surface of the reflection unit. The width of the periodically occurring coherence windows is preferably between 100-300 μm.

Preferably, the device comprises means for maintaining the distance between neighboring coherence centers of the laser beam produced by the semiconductor laser. Such a means for maintaining the distance between neighboring coherence centers guarantees that the path difference between focused radiation and contradirectionally superimposed radiation (that is the distance between the reflecting surface of the reflection unit and the focus in the storage medium) can be kept constant without suffering a deterioration of the contrast. Preferably, the means for maintaining the distance between neighboring coherence centers is formed by means for constancy control of the current applied to the semiconductor laser and/or means for constancy control of the temperature of the semiconductor laser. Alternatively it is preferred that the means for maintaining the distance between neighboring coherence centers is formed by means for maintaining the path difference and the distance focus—reflector.

Preferably, the means for focusing comprises at least one aspherical lens. Preferably, the means for focusing comprises an aspherical lens and a meniscus lens. Preferably, the reflection unit comprises at least one aspherical lens and a plane mirror. Preferably, the reflection unit comprises an aspherical lens, a meniscus lens, and a plane mirror. Alternatively the reflection unit is formed by a curved mirror.

The storage medium is preferably formed as a plane-parallel plate (disc) and comprises a material which undergoes a change in refractive index upon incidence of electromagnetic radiation. Preferably, the distance between the reflecting surface of the reflection unit and the storage medium is fixed, i.e. not variable in time. In an alternative embodiment of the invention, the distance between the reflecting surface of the reflection unit and the storage medium as well as the distance (Δs) between neighboring coherence centers of the laser beam produced by the semiconductor laser are variable in time while always maintaining the above-mentioned relationship to each other. In such a case it is provided to determine the distance (Δs) between neighboring coherence centers and to adjust (to correct) the distance between the reflecting surface of the reflection unit and the storage medium in situ accordingly.

According to an alternative embodiment of the invention, the incident laser beam is first divided and a time delay (which corresponds to an optical path length difference Δz) is applied to a partial beam and the partial beams are then superimposed collinearly (propagating along the same optical axis). Then, the reflection unit is arranged such that at least one of the following conditions (i) and (ii) is satisfied:

$$\begin{matrix}2 {\int }_{P 1}^{P 2} n ( z ) d z = a * Δ s \pm 150 µm & ( i ) \\ 2 {\int }_{P 1}^{P 2} n ( z ) d z - Δ z = a * Δ s \pm 150 µm , & ( ii )\end{matrix}$$

wherein P1 is the location of the focus of the laser beam of the semiconductor laser in the storage medium, P2 is the intersection of the reflecting surface of the reflection unit with the optical axis defined by the laser beam of the semiconductor laser, n(z) is the refractive index of the medium between the points P1 and P2 along the optical axis, Δz is the optical path length difference between the at least two partial beams, a is a natural number greater than or equal to 0, and Δs is a distance between neighboring coherence centers of the laser beam produced by the semiconductor laser.

For equation (i): The parameter a is preferably between 0 and 10 (more preferably 0 or 1). Preferably, the two partial beams have the same intensity or nearly the same intensity.

For equation (ii): The parameter a is preferably between 1 and 10 (more preferably 1 or 2). Preferably, the two partial beams have the same intensity or nearly the same intensity.

The idea is to adjust the path difference not only to the distance (Δs) between neighboring coherence centers, but both to the distance (Δs) between neighboring coherence centers and to the applied delay (optical path length difference Δz) between the partial beams. Then the delayed and the undelayed partial beam (=condition (ii)) or the respective partial beams with each other (=condition (i)) can interfere with the highest possible contrast.

The means for producing at least two partial beams from the laser beam of the semiconductor laser and subsequently superimposing the partial beams with an optical path length difference (Δz) is preferably formed by two beam splitters and a deflecting prism.

Preferably, the reflection unit is arranged such that the optical path length between the focus of the laser beam in the storage medium and the reflecting surface of the reflection unit satisfies the condition Δx=0.5*Δs*a+Δz in the region of the optical axis, wherein Δz is the optical path length difference between the at least two partial beams, a is a natural number greater than or equal to 1 and Δs is a distance between neighboring coherence centers of the laser beam produced by the semiconductor laser.

The method for producing holograms in a storage medium according to the invention comprises the following method steps: providing a semiconductor laser, providing a storage medium with a storage layer whose refractive index undergoes a change upon incidence of electromagnetic radiation, focusing and contradirectional superposition of electromagnetic radiation of the semiconductor laser such that an interference pattern forms in the storage layer due to the contradirectional superposition and leads to a greater change in refractive index in the focus in regions of constructive interference than in regions of destructive interference, and a hologram with a plurality of layers with alternating refractive index is produced due to the change in refractive index, wherein the radiation of the semiconductor laser focused into the storage layer is reflected back into itself using a reflection unit and is contradirectionally superimposed to form an interference pattern, wherein the reflection unit is arranged such that the following condition is satisfied:

$$2 {\int }_{P 1}^{P 2} n ( z ) d z = a * Δ s \pm 150 µm ,$$

wherein P1 is the location of the focus of the laser beam of the semiconductor laser in the storage medium, P2 is the intersection of the reflecting surface of the reflection unit with the optical axis defined by the laser beam of the semiconductor laser, n(z) is the refractive index of the medium between the points P1 and P2 along the optical axis, i.e. along the course of the radiation of the semiconductor laser from the focus to the reflecting surface, a is a natural number greater than or equal to 1, and Δs is a distance between neighboring coherence centers of the laser beam produced by the semiconductor laser.

According to an alternative embodiment of the invention, the method for producing holograms in a storage medium according to the invention comprises the following method steps: Providing a semiconductor laser, dividing the radiation of the semiconductor laser into at least a first partial beam and a second partial beam, subsequently superimposing the first and the second partial beam, wherein after the division and before the superposition the partial beams are guided such that they exhibit a delay with respect to each other corresponding to an optical path length difference, providing a storage medium with a storage layer whose refractive index undergoes a change upon incidence of electromagnetic radiation, focusing and contradirectional superposition of the superimposed partial beams of the semiconductor laser such that an interference pattern forms in the storage layer due to the contradirectional superposition and leads to a greater change in refractive index in the focus in regions of constructive interference than in regions of destructive interference, and a hologram with a plurality of layers with alternating refractive index is produced due to the change in refractive index, wherein the radiation of the semiconductor laser focused into the storage layer is reflected back into itself using a reflection unit and is contradirectionally superimposed to form an interference pattern, wherein the reflection unit is arranged such that at least one of the following conditions (i) and (ii) is satisfied:

$$\begin{matrix}2 {\int }_{P 1}^{P 2} n ( z ) d z = a * Δ s \pm 150 µm & ( i ) \\ 2 {\int }_{P 1}^{P 2} n ( z ) d z - Δ z = a * Δ s \pm 150 µm , & ( ii )\end{matrix}$$

wherein P1 is the location of the focus of the laser beam of the semiconductor laser in the storage medium, P2 is the intersection of the reflecting surface of the reflection unit with the optical axis defined by the laser beam of the semiconductor laser, n(z) is the refractive index of the medium between the points P1 and P2 along the optical axis, Δz is the optical path length difference between the at least two partial beams, a is a natural number greater than or equal to 1, and Δs is a distance between neighboring coherence centers of the laser beam produced by the semiconductor laser.

The coherence length of the employed laser radiation is preferably greater than the hologram depth (extension along the optical axis).

Preferably, the reflection unit is arranged such that the parameter a is between 1 and 10 (more preferably between 1 and 5).

Holograms are produced using interfering laser beams that are superimposed in the optical medium. The invention is applicable both for producing transmission holograms, in which writing beams are directed into the optical medium from the same side, and for producing reflection holograms, in which writing beams are incident on the optical medium from different sides.

A preferred development of the invention provides for the hologram to be produced as a micro-hologram by focusing the laser beams onto the optical medium. The forming of the micro-hologram is limited to a submicrometer range in all spatial directions.

In a convenient embodiment of the invention, it may be provided that data is stored bitwise using the hologram. In a simple encoding scheme, the hologram represents a single bit, namely a binary one or a binary zero. In an advantageous encoding scheme, the data content is encoded by the length of the dynamically produced micro-holograms of variable length along the direction of motion of the storage medium. An advantageous embodiment of the invention provides for several holograms to be formed in several planes configured for data storage.

In an advantageous embodiment of the invention, it may be provided for the laser beams to be directed onto the optical medium using a writing system which comprises two writing optics, each optionally realized as an aspherical lens, between which the optical medium is arranged, two meniscus lenses, of which each meniscus lens is associated with a respective writing optics and which are arranged behind the associated writing optics from the viewpoint of the optical medium, as well as a reflector with a substantially plane reflection face, which is arranged at a distal end, reflecting an incident laser beam back onto the optical medium, wherein a distance x between an overlapping region of the laser beams in the optical medium and the reflection face is set according to an integer multiple of half of the distance Δs between the coherence centers of the laser beam emitted by the free-running semiconductor laser, so that x=n(Δs/2) if n is an integer.

A development of the invention can provide for a distance between the reflection face and the writing optics opposite the reflector to be fixed.

A preferred development of the invention provides for the following steps:

dividing the laser beam emitted by the free-running semiconductor laser into two partial laser beams before it reaches the optical medium using a beam splitter apparatus,

forming an undelayed laser beam and a delayed laser beam from the two partial laser beams by delaying one of the two partial laser beams in time with respect to the other of the two partial laser beams, and

radiating the undelayed laser beam and the delayed laser beam onto the medium with a writing system, wherein an undelayed signal beam and an undelayed reference beam are formed from the undelayed laser beam and an undelayed signal beam and an undelayed reference beam are formed from the delayed laser beam using the writing system, which are directed onto the optical medium while being superimposed in the optical medium and at least partially interfering therein.

With the proper setting, partial beams capable of interfering are thus present at the writing location of the hologram. A hologram with higher contrast can be produced if the periodically repeating coherence centers of the employed laser radiation coincide with the beam focuses, whereby the laser beams are superimposed coherently.

The above-mentioned embodiment in its different forms can also be used with other light sources with sufficient luminance and short coherence length, independent of the use of a free-running semiconductor laser, if the coherence length is greater than the axial extension of the hologram.

In a convenient embodiment of the invention it may be provided that the two partial laser beams are formed according to an intensity ratio of approximately 50:50.

In the following, advantageous embodiments of the device for producing a hologram in an optically active region of a medium are explained in more detail.

An advantageous embodiment of the invention provides for the writing system to comprise a focusing apparatus configured to focus the coherent contradirectional laser beams into the optical medium.

Preferably, a development of the invention provides for forming a control apparatus configured to adjust operating parameters of the free-running semiconductor laser according to a constancy control in order to maintain at least one coherence parameter of the laser beam emitted by the free-running semiconductor laser.

In an advantageous embodiment of the invention, it may be provided for the writing system to comprise two writing optics, each optionally realized as an aspherical lens, between which the optical medium is arranged, two meniscus lenses, of which each meniscus lens is associated with a respective writing optics and which are arranged behind the associated writing optics from the viewpoint of the optical medium, as well as a reflector with a substantially plane reflection face, which is arranged at a distal end, reflecting an incident laser beam back onto the optical medium, wherein a distance x between an overlapping region of the laser beams in the optical medium and the reflection face is set according to an integer multiple of half of the distance Δs between the coherence centers of the laser beam emitted by the free-running semiconductor laser, so that x=n(Δs/2) if n is an integer.

A development of the invention can provide for a distance between the reflection face and the writing optics opposite the reflector to be fixed.

A preferred development of the invention provides:

a beam splitter apparatus configured to divide the laser beam emitted by the free-running semiconductor laser into two partial laser beams before it reaches the optical medium, and

an optical delay apparatus configured to form an undelayed laser beam and a delayed laser beam from the two partial laser beams by delaying one of the two partial laser beams in time with respect to the other of the two partial laser beams along a delay line.

The device for producing a hologram can preferably be used in a data writing/data reading apparatus for writing data into/for reading data from an optical storage medium. A use of the device in a writing/reading head for a data storage system is also an advantageous usage of the provided device.

### DRAWINGS

In the following, the invention is explained in more detail by means of preferred exemplary embodiments with reference to figures of a drawing, of which:

FIG. 1 is a schematic illustration of a writing system for producing a hologram in a storage medium according to the state of the art;

FIG. 2 shows a mode profile of a multimode laser diode with a central wavelength of 405 nm;

FIG. 3 is a graphical illustration of the superposition of neighboring longitudinal waves (standing wave fields) in a resonator to constant intensity;

FIG. 4 is a graphical illustration of a modulation part of several neighboring modes in a resonator with a length of 3.2 mm;

FIG. 5 is a graphical illustration of the spectral width of a single mode;

FIG. 6 is a graphical illustration of the coherence behavior of a laser beam of a free-running laser diode, wherein coherence centers are shown at intervals of Δs;

FIG. 7 is a schematic illustration of a writing system for writing micro-holograms; and

FIG. 8 is a schematic illustration of a configuration with a beam splitter apparatus and an optical delay line.

### DETAILED DESCRIPTION

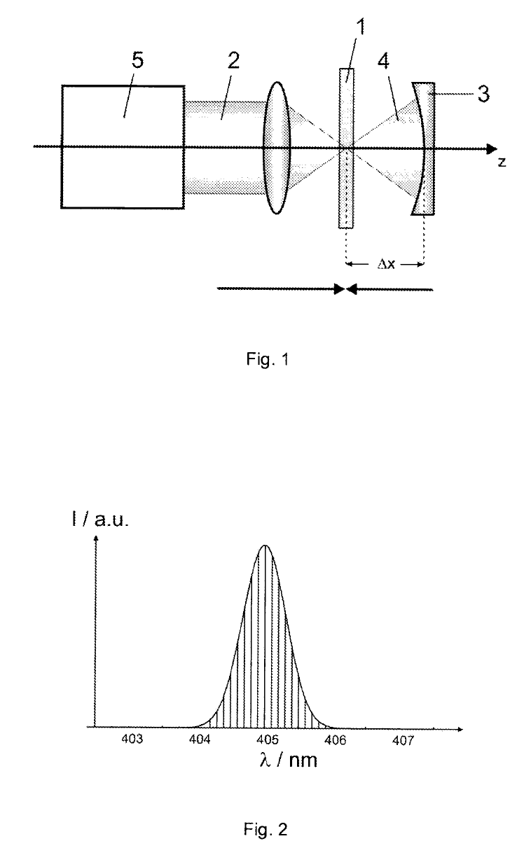

In the following, preferred exemplary embodiments of the invention are explained in more detail with reference to FIGS. 1 to 8. The exemplary embodiments have in common the use of a laser beam from a free-running semiconductor laser, particularly a free-running laser diode, for writing one or more holograms.

The spectrum of a semiconductor laser preferably realized as a laser diode, as exemplified in FIG. 2 as a mode profile of a multimode laser diode with a central wavelength of 405 nm, generally has a width of one to two nanometers, which results in a relatively short coherence length of at most several hundred micrometers. However, due to the small resonator length of the laser diode of under one millimeter, within the wide gain profile only 10 to 20 discrete modes with a small line width of 10⁻³ to 10⁻² nm actively contribute to the laser emission.

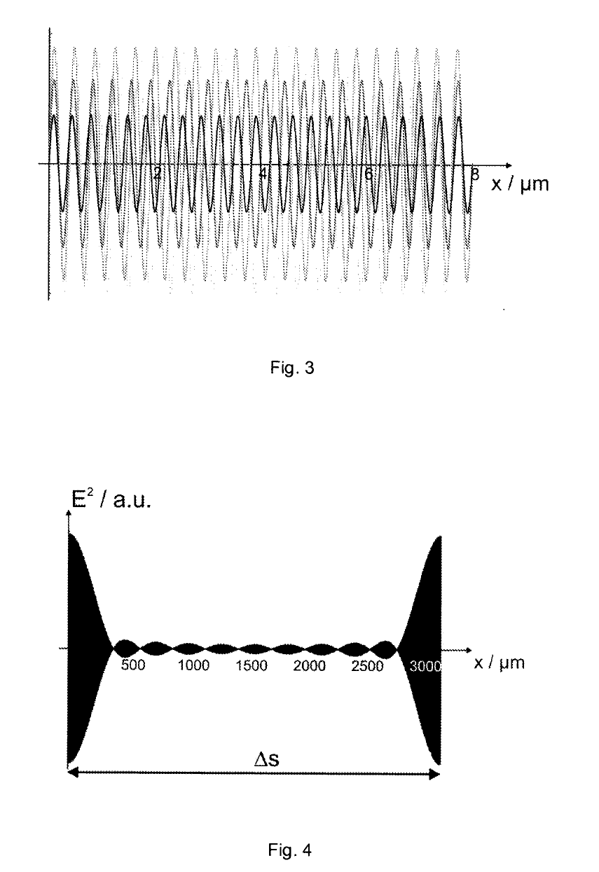

FIG. 3 is a graphical illustration of the superposition of neighboring longitudinal waves (standing wave fields) in a resonator. FIG. 4 shows the modulation part of several neighboring modes in a resonator with a length of 3.2 mm. Interference can only occur in the external regions.

If the line widths of the single modes are disregarded at first and the latter are superimposed, within the laser resonator or in the writing region of the holographic system, the amplitudes of the standing wave fields of all single modes illustrated in FIG. 3 add up. FIG. 3 already indicates that within the resonator the amplitudes of the single modes add up to a mean, spatially non-constant intensity. Interference does not occur. The phases of the individual standing wave fields are approximately equal only in the outer regions, so that spatially constant regions of high intensity and of low intensity develop there.

The superposition of eleven neighboring modes with a central wavelength of 405 nm in a resonator with a length of 1.6 mm is calculated in FIG. 4. The individual oscillations of the standing wave can no longer be resolved. However, the envelope illustrated in the graph directly represents the coherence of the beam thus defined, namely the interference structure, i.e. the modulated portion of the total intensity. The interpretation of this graph is that the coherence which is present in the first hundred micrometers of distance from the laser resonator, on the left-hand side of the graph, repeats periodically after the resonator length of 3.2 mm in this case, on the right-hand side of the graph, so that a periodic behavior of the laser coherence arises for all multiples of this distance.

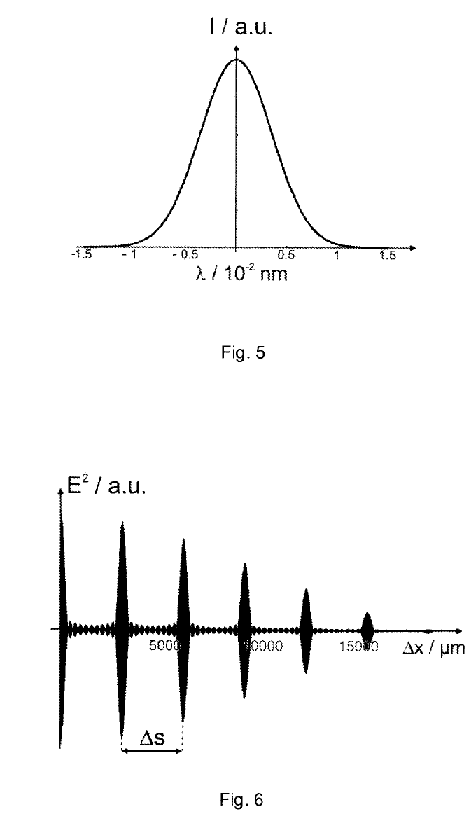

If the real line width of each single mode is now taken into account as well, the coherence behavior illustrated in FIG. 5 results. The envelope of the standing wave field is the fourier transform of the spectral emission profile of all modes of the laser diode. Coherence is present if the path difference between two partial beams of the laser corresponds to a multiple n of the distance Δs=3.2 mm. Here, the finite line width of the single modes causes a decrease in coherence for greater path length differences a·Δs.

FIG. 5 shows the spectral width of a single mode. FIG. 6 shows the coherence behavior for a path length difference Δx between two superimposed partial beams.

This behavior was demonstrated experimentally using a Michelson interferometer for a multimode laser diode from Sanyo. The result was Δs=2 mm, a respective coherence length of 150 μm and a maximal path length difference of 20 cm within which the periodically occurring interference with high contrast could be observed.

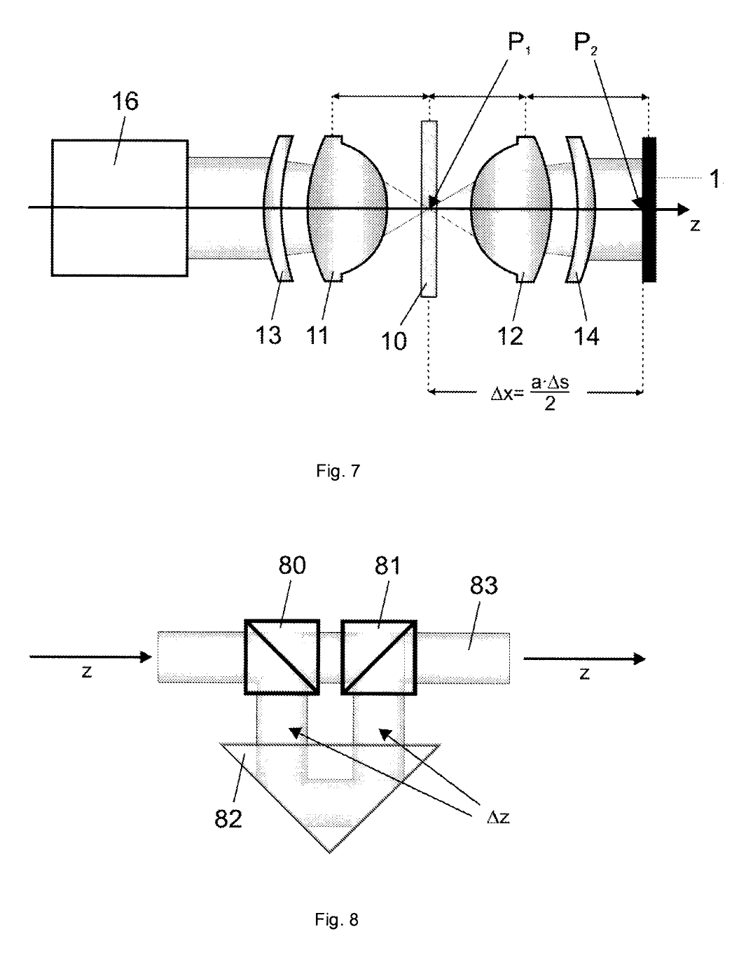

The doubled optical path of the laser beam from the focus position in the storage material to the reflector 2·Δx can be adjusted exactly to a smallest possible multiple of the periodicity Δs of the laser coherence by varying the reflector position, as shown in FIG. 7, which is a schematic illustration of a writing system for writing micro-holograms. The writing system for writing a hologram using a laser diode 16, namely a reflection lattice, in a storage medium 10 comprises two aspherical lenses 11, 12 for focusing the laser beams into the storage medium 10, two outer meniscus lenses 13, 14, and a reflector 15 realized as a mirror.

The position of the reflector 15 can be arbitrarily varied in the range of several centimeters without the image in the storage medium 10 changing significantly since the beam is imaged onto the reflector 15 as a parallel beam bundle. The distance between mirror 15 and the beam focus (inside the storage medium 10) is adjusted once to a multiple of half of the coherence periodicity Δs. Here the coherence periodicity Δs is a characteristic of the laser diode 16. Preferably, the parameters for driving the laser diode 16 are controlled such that the coherence periodicity Δs can be kept constant. Then the distance Δx can also be kept constant.

Part of the holographic storage concept is the storage of data in several planes within the storage medium 10, which in the exemplary embodiment is a transparent photopolymer material 200 to 300 μm thick. Storage in several planes, preferably in up to 100 planes, may be provided. Addressing a given depth of the storage medium 10 with signal and reference beam focus therefore takes place by axial adjustment of the two aspherical lenses 11, 12 adjacent to the material. The outer meniscus lenses 13, 14 which are also to be readjusted additionally provide a correction of the occurring spherical aberration at the plane boundary surfaces of the storage medium 10. If the aspherical lenses 11, 12 functioning as writing objectives are displaced axially by a distance Δa, the reflector 15 has to be repositioned accordingly to guarantee a constant coherence condition at the writing location. Accordingly, the writing unit in which the optics and the reflector 15 are located on corresponding actuators (not shown), has to be constructed such that the distance m between the rear aspherical lens 12 and the reflector 15 is always constant.

The distance m that optimizes the coherence condition at the writing location has to be preadjusted once for the holographic system. To this end, an algorithm which for example whenever a new data carrier is inserted repeatedly writes micro-reflection lattices in a region which is not to be used later on, reads them out again immediately and varies the distance m until the reflectivity of the micro-reflection lattices is maximal, is implemented in the system with software.

The system described uses the time constancy of the distance of the coherence centers Δs in the laser beam emitted by a free-running semiconductor laser (not shown) preferably realized as a laser diode. Its behavior in time Δs(t)∞n(t)·L(t) depends directly on the refractive index of the resonator n and its length L. Accordingly, the operating parameters current I and temperature T are continuously tuned to a constant value via corresponding electronics in combination with a temperature sensor.

In another exemplary embodiment, the use of a free-running semiconductor laser for holographic storage is based on compensation of the path length difference in the writing region through use of a delay line for a certain part of the laser beam used for writing. Alternatively to the use of a free-running semiconductor laser, this embodiment in its different forms may also be used with other light sources with sufficiently high luminance and short coherence length if the coherence length is greater than the axial extension of the hologram to be written.

FIG. 8 is a schematic illustration of a configuration with a beam splitter apparatus and an optical delay line.

The beam of the free-running laser diode with a coherence length of a few 100 μm is divided in the beam path before the writing region, i.e. before reaching the storage medium, using two 50:50 beam splitters 80, 81 and is reunited. A prism 82 with highly reflecting outer surfaces is positioned on an adjustable axis such that the distance to the continuous beam axis Δz=a*Δs (a=0, 1, 2, . . . ) can be arbitrarily set. The prism 82 and both beam splitters 80, 81 are mounted such that both beams are once again superimposed exactly after being reunited.

When the beams are reunited, 50% of the total power of a continuous beam A and a beam B passed through the prism 82 are lost. A new writing beam 83 created in this way consists of the two partial beams A and B, wherein B is delayed by the distance Δz with respect to A. In the writing region (not shown), a signal beam (A′+B′) is now created from the reference beam (A+B) by reflection. For example, a configuration as schematically illustrated in FIG. 1 can be used as a writing system. The superposition of signal and reference beam in the storage medium can be viewed as a superposition of the four beam pairs (A,A′), (A,B′), (B,A′) and (B,B′), wherein due to the previous delay line only the beam pair (B,A′) is capable of interference. To this modulated intensity part in the storage material, the spatially constant intensities of the three other beam pairs are now added, so that the contrast of the interference structure is reduced in comparison to the use of a light source with sufficiently high coherence.

For this reason, this concept preferably uses a photosensitive storage material which has a chemical initiation threshold for the exposure. In this case, the homogeneous base intensity in the material is set such that precisely the modulated part exceeds the exposure threshold and therefore leads to an optimal exploitation of the possible material modulation. Basically the use of such a material is also advantageous for the storage method in other aspects, so that this second approach mainly depends on the availability of the corresponding photosensitive material.

In this alternative approach, the system also has to be preadjusted once. To this end, analogously to the algorithm described above, micro-lattices are written into the storage medium at different prism distances Δz and read out again. The prism is then readjusted in the direction of increasing diffraction efficiency of the lattices until a position with an optimal writing result is reached.

The exemplary embodiments described are also suitable for other holographic storage systems, particularly for page-oriented storage, if, due to the particular writing configuration, a path length difference between signal and reference beam cannot be avoided or is not practicable. The prerequisite is, however, that the available “local” coherence is sufficient for the corresponding application, i.e. path length differences between the locally interfering parts of the reference and the signal beam must not exceed the length of the coherence region of the laser source. However, this is the case for most holographic writing configurations, so that both of the concepts described can be used.

Furthermore, applications in interferometry can be provided, where larger path length differences of the two interfering beams also occur, but a measuring device is to be equipped with an inexpensive, small and economical laser diode for cost, space or energy efficiency reasons (device working with batteries/rechargeable batteries).

The features of the invention disclosed in the preceding description, the claims and the drawing can individually as well as in an arbitrary combination be of importance for the realization of the invention in its different embodiments.

List of Reference Signs

1 storage medium

2 incident laser beam

3 reflection unit

4 reversed laser beam

5 semiconductor laser

10 storage medium

11 aspherical lens

12 aspherical lens

13 meniscus lens

14 meniscus lens

15 reflection unit

16 semiconductor laser/laser diode

80 beam splitter

81 beam splitter

82 prism

83 writing beam with undelayed and delayed partial beam

z optical axis

P1 focus

P2 reflecting surface of the reflection unit

1. A device for producing holograms in a storage medium, comprising:
a semiconductor laser,
a reception means for the storage medium;
a means for focusing the beam produced by the semiconductor laser into the storage medium,
a reflection unit with a reflecting surface adapted to focus at least a part of the laser beam of the semiconductor laser passing through the storage medium back into the storage medium,
wherein
the reflection unit is arranged such that the following condition is satisfied:
$$2 {\int }_{P 1}^{P 2} n ( z ) d z = a * Δ s \pm 150 µm ,$$
wherein P1 is the location of the focus of the laser beam of the semiconductor laser in the storage medium, P2 is the intersection of the reflecting surface of the reflection unit with the optical axis defined by the laser beam of the semiconductor laser, n(z) is the refractive index of the medium between the points P1 and P2 along the optical axis, a is a natural number greater than or equal to 1, and Δs is a distance between neighboring coherence centers of the laser beam produced by the semiconductor laser.

2. The device according to claim 1,
wherein
the semiconductor laser is a laser diode with a central wavelength between 300 nm and 430 nm.

3. The device according to claim 2,
wherein
the reflection unit is arranged such that the optical path length Δx between the focus of the laser beam in the storage medium and the reflecting surface of the reflection unit satisfies the condition
Δx=0.5*Δs*a±150 μm
in the region of the optical axis, wherein a is a natural number greater than or equal to 1, and Δs is a distance between neighboring coherence centers of the laser beam produced by the semiconductor laser.

4. The device according to claim 3,
wherein
the laser diode comprises a Fabry-Perot resonator with a front facet and a rear facet, wherein the distance between neighboring coherence centers satisfies the condition
Δs=r±150 μm,
wherein r is the distance between the front facet and the rear facet of the internal resonator of the laser diode.

5. The device according to claim 4,
wherein
the device does not comprise an external resonator for the semiconductor laser.

6-7. (canceled)

8. The device according to claim 5,
wherein
the device comprises means for maintaining the distance between neighboring coherence centers of the laser beam produced by the semiconductor laser.

9-13. (canceled)

14. The device according to claim 8,
wherein
the storage medium is formed as a plane-parallel plate and comprises a material which undergoes a change in refractive index upon incidence of electromagnetic radiation.

15. (canceled)

16. The device according to claim 14,
wherein
the distance between the reflecting surface of the reflection unit and the storage medium is fixed.

17. A device for producing holograms in a storage medium, comprising:
a semiconductor laser,
a reception means for the storage medium;
a means for producing at least two partial beams from the laser beam of the semiconductor laser and subsequently superimposing the partial beams with an optical path length difference Δz,
a means for focusing the superimposed partial beams into the storage medium,
a reflection unit with a reflecting surface adapted to focus at least a part of the partial beams passing through the storage medium back into the storage medium,
wherein
the reflection unit is arranged such that at least one of the following conditions (i) and (ii) is satisfied:
$$\begin{matrix}2 {\int }_{P 1}^{P 2} n ( z ) d z = a * Δ s \pm 150 µm & ( i ) \\ 2 {\int }_{P 1}^{P 2} n ( z ) d z - Δ z = a * Δ s \pm 150 µm , & ( ii )\end{matrix}$$
wherein P1 is the location of the focus of the laser beam of the semiconductor laser in the storage medium, P2 is the intersection of the reflecting surface of the reflection unit with the optical axis defined by the laser beam of the semiconductor laser, n(z) is the refractive index of the medium between the points P1 and P2 along the optical axis (z), Δz is the optical path length difference between the at least two partial beams, a is a natural number greater than or equal to 0, and Δs is a distance between neighboring coherence centers of the laser beam produced by the semiconductor laser.

18. The device according to claim 17,
wherein
the means for producing at least two partial beams from the laser beam of the semiconductor laser and subsequently superimposing the partial beams with an optical path length difference is formed by two beam splitters and a deflecting prism.

19. The device according to claim 18,
wherein
the semiconductor laser is a laser diode with a central wavelength between 300 nm and 430 nm.

20. The device according to claim 19,
wherein
the reflection unit is arranged such that the optical path length Δx between the focus of the laser beam in the storage medium and the reflecting surface of the reflection unit satisfies the condition
Δx=0.5*Δs*a+Δz±150 μm
in the region of the optical axis, wherein Δz is the optical path length difference between the at least two partial beams, a is a natural number greater than or equal to 0, and Δs is a distance between neighboring coherence centers of the laser beam produced by the semiconductor laser.

21. The device according to claim 20,
wherein
the laser diode comprises a Fabry-Perot resonator with a front facet and a rear facet, wherein the distance between neighboring coherence centers satisfies the condition
Δs=r±150 μm,
wherein r is the distance between the front facet and the rear facet of the internal resonator of the laser diode.

22. The device according to claim 21,
wherein
the device does not comprise an external resonator for the semiconductor laser.

23-24. (canceled)

25. The device according to claim 21,
wherein
the device comprises means for maintaining the distance between neighboring coherence centers of the laser beam produced by the semiconductor laser.

26-30. (canceled)

31. The device according to claim 25,
wherein
the storage medium is formed as a plane-parallel plate and comprises a material which undergoes a change in refractive index upon incidence of electromagnetic radiation.

32. (canceled)

33. The device according to claim 31,
wherein
the distance between the reflecting surface of the reflection unit and the storage medium is fixed.

34. A method for producing holograms in a storage medium, comprising the following method steps:
providing a semiconductor laser,
providing a storage medium with a storage layer whose refractive index undergoes a change upon incidence of electromagnetic radiation,
focusing and contradirectionally superimposing electromagnetic radiation of the semiconductor laser such that an interference pattern forms in the storage layer due to the contradirectional superposition and leads to a greater change in refractive index in the focus in regions of constructive interference than in regions of destructive interference, and a hologram with a plurality of layers with alternating refractive index is produced due to the change in refractive index,
wherein the radiation of the semiconductor laser focused into the storage layer is reflected back into itself by a reflection unit and is contradirectionally superimposed to form an interference pattern,
wherein
the reflection unit is arranged such that the following condition is satisfied:
$$2 {\int }_{P 1}^{P 2} n ( z ) d z = a * Δ s \pm 150 µm ,$$
wherein P1 is the location of the focus of the laser beam of the semiconductor laser in the storage medium, P2 is the intersection of the reflecting surface of the reflection unit with the optical axis defined by the laser beam of the semiconductor laser, n(z) is the refractive index of the medium between the points P1 and P2 along the optical axis, a is a natural number greater than or equal to 0, and Δs is a distance between neighboring coherence centers of the laser beam produced by the semiconductor laser.

35. The method for producing holograms in a storage medium of claim 34,
further comprising:
dividing the radiation of the semiconductor laser into at least one first partial beam and one second partial beam,
subsequently superimposing the first and the second partial beam, wherein after the division and before the superposition the partial beams are guided such that they exhibit a delay with respect to each other corresponding to an optical path length difference Δz,
wherein
the reflection unit is arranged such that at least one of the following conditions (i) and (ii) is satisfied:
$$\begin{matrix}2 {\int }_{P 1}^{P 2} n ( z ) d z = a * Δ s \pm 150 µm & ( i ) \\ 2 {\int }_{P 1}^{P 2} n ( z ) d z - Δ z = a * Δ s \pm 150 µm , & ( ii )\end{matrix}$$
wherein P1 is the location of the focus of the laser beam of the semiconductor laser in the storage medium, P2 is the intersection of the reflecting surface of the reflection unit with the optical axis defined by the laser beam of the semiconductor laser, n(z) is the refractive index of the medium between the points P1 and P2 along the optical axis, Δz is the optical path length difference between the at least two partial beams, a is a natural number greater than or equal to 1, and Δs is a distance between neighboring coherence centers of the laser beam produced by the semiconductor laser.

36. (canceled)

37. The method according to claim 35,
wherein
the reflection unit is arranged such that the natural number a lies between 1 and 5.
